(19) United States
(12) Patent Application Publication
(10) Pub. No.: US 2004/0035303 A1
(43) Pub. Date: Feb. 26, 2004

(54) Tools and process for forming conical components

(76) Inventor: Emlyn J Smith, Bristol (GB)

Correspondence Address: NIXON & VANDERHYE, PC, 1100 N GLEBE ROAD, 8TH FLOOR, ARLINGTON, VA, 22201-4714, US

(21) Appl. No.: 10/276,710

(22) PCT Filed: Jan. 5, 2001
(86) PCT No.: PCT/GB01/01908

(30) Foreign Application Priority Data
May 18, 2000 (GB) 0011894.3

(51) Int. Cl. B30B 3/00

(52) U.S. Cl. 100/155 R

(57) ABSTRACT

This invention relates to a press (20) for forming a conical component (58) from sheet metal or the like and to a method of forming a conical component (58) from a metal sheet (53) or the like. The press (20) comprises two spaced elongate arm members (39, 40) and an elongate tool member (23) movable between a clear position in which the tool member (23) is clear of a gap (41) between the arm members (39, 40) and an interposed position in which at least a portion of the tool member (23) penetrates the gap (41), wherein a member (23, 49, 50) is disposed out of parallel alignment with at least one of the other members (23, 49, 50). The required alignment may be achieved by arranging the press (20) such that, when in the interposed position, the penetration of the tool member (23) into the gap (41) is greater at one end (24) of the tool member (23) than the other (25). Alternatively or additionally, the arm members (49, 50) may diverge along their length.

This invention relates to tools and processes for forming conical components from sheet metal or other plastically deformable sheet material. In particular, this invention relates to such tools and processes used to form small conical components such as components for airframes.

Generally, large conical components are rolled into shape by machines that comprise a pair of parallel rollers, with a third roller placed above them so that its bottom penetrates the gap between the lower rollers. A conical shape is imparted to a metal sheet rolled through the machine because the penetration of the top roller into the gap is greater at one end of its ends than the other. It will be appreciated that the greater the difference in penetration between ends, the greater the taper of the conical components that the machine produces.

Whilst the rolling machine described hereinabove produces satisfactory large conical components, it cannot be scaled down to shape small conical components because of two reasons. Firstly, the resilience of metal sheets causes them to unroll after forming and hence lose any imparted conical shape. This is particularly true for titanium sheet metal. Secondly, the reduced size of the rollers greatly reduces their strength so that they rapidly bend out of shape.

Instead, small conical components are generally formed by hand. Commonly, a sheet of metal is hammered into the desired conical shape on a resilient rubber bed using a shaped hammer. As will be appreciated, this method is very time consuming and requires great skill on the part of the operator to form the desired correctly-sized conical component, particularly where tolerances are small. Accordingly, components made in this fashion are inevitably expensive and prone to imperfections either in their finish or, worse still, in their overall size.

It is an object of this invention to provide a machine suitable for forming small conical components from sheet metal, or other plastically-deformable sheet material, that overcomes disadvantages of the prior art. Moreover, it is an object of the invention to provide a convenient method of forming small conical components.

From a first aspect, the invention resides in a press for forming a conical component from sheet metal or the like comprising two spaced elongate arm members and an elongate tool member movable between a clear position in which the tool member is clear of a gap between the arm members and an interposed position in which at least a portion of the tool member penetrates the gap, wherein a member is disposed out of parallel alignment with at least one of the other members.

From a second aspect, the invention resides in a method of forming a conical component from a metal sheet or the like having first and second opposed sides comprising: supporting the first side of the metal sheet with two spaced elongate arm members of a press and moving a tool member of the press towards the arm members to contact the second side of the metal sheet and subsequently to urge the metal sheet into a gap between the arm members, a member-contacted length of the metal sheet not being parallel with at least one of the other member-contacted lengths of the metal sheet; moving the metal sheet across the arm members; and repeating the movement of the tool member.

The non-parallel arrangement of the members results in the metal sheet being shaped with a taper which, when the sheet has been successively shaped in accordance with the second aspect of the invention, will result in a conical form.

In a preferred embodiment, the press is arranged such that, when in the interposed position, the penetration of the tool member into the gap is greater at one end of the tool member than the other, so that the tool member is not parallel with either arm member. The curvature imparted to the metal sheet will increase as the penetration of the tool member into the gap increases along the length of the gap. In an alternative embodiment, the arm members diverge along their length, so that the arm members are not parallel. As will be appreciated, the curvature imparted to the metal sheet will decrease as the separation of the arms increases. The two alternative embodiments described in this paragraph may be combined to yield a press having mutually non-parallel arm members and tool member. Preferably, the penetration of the tool member into the gap would increase as the width of the gap decreased.

In a particularly preferred embodiment, the press is arranged such that, when in the interposed position, the tool member is substantially equidistant from the arm members. This arrangement ensures that the metal sheet is deformed evenly across the width of the gap.

As the conical component is formed progressively according to the second aspect of the invention, the part-formed conical component will wrap itself around the elongate tool member. Consequently it is convenient to ensure that the central forming portion of the tool member is unobstructed. Optionally, the tool member may be supported at only one end portion in cantilever fashion. This is convenient as it allows a formed conical component to be slid from the tool member. Alternatively, the tool member may be detachably supported at both end portions. Detaching the tool member from its supports allows a formed component to be slid from the tool member. For ease of removal of the tool member, the tool member may be supported at a short distance from one end leaving a portion of the tool member projecting beyond the support. This ensures that at least a part of the tool member can be grasped by an operator, even when a formed conical component is wrapped around the central forming portion of the tool member.

Conveniently, a support for the tool member is clear of the arm members when the tool member is moved into the interposed position.

Optionally, a forming portion of the tool member has a curved forming surface. This is advantageous because it ensures that a smooth curvature is imparted to the metal sheet at the line of contact: using an edge to contact the metal sheet will leave crease marks in the component and an acceptable conical form may not result.

In a further preferred embodiment, the tool member is a solid bar, which is advantageous in terms of strength and/or damage tolerance.

The travel of the tool member into the gap may be limited by limiting means. Optionally, this may be achieved by arranging the press such that progressive movement of a lever arm causes reciprocating motion of the tool member from the clear position into the interposed position and then back towards the clear position. Conveniently, the reciprocating motion may be effected by a cam. It is advantageous to limit the travel of the tool into the gap because excessive travel imparts too great a curvature to the sheet metal. Whilst it is relatively difficult to straighten the metal sheets, it is far easier to increase their curvature by performing another pressing operation as would be necessary if the tool member was not driven far enough into the gap.

The press may be arranged such that an operator may use one hand to operate a lever arm to move the tool member between the clear and interposed position and, optionally, use his other hand to hold the metal sheet in position in the press.

In a yet still further preferred embodiment, the arm members are formed integrally in a die. This is advantageous as it gives the arm members strength and guaranteed reproducibility in positioning, which is particularly important as the arm members must be in the same plane, even if they diverge within that plane.

Conveniently, the press is adapted to allow selection of the tilt of the die relative to the tool, such that the variation in penetration between the ends of the tool member when in the interposed position can be adjusted. This allows conical components of varying degrees of taper to be produced by the same press: the shallower the angle between the tool member and the arm members, the less the taper of the conical component.

In order that the invention can be more readily understood, reference will now be made, by way of example only, to the accompanying drawings in which:

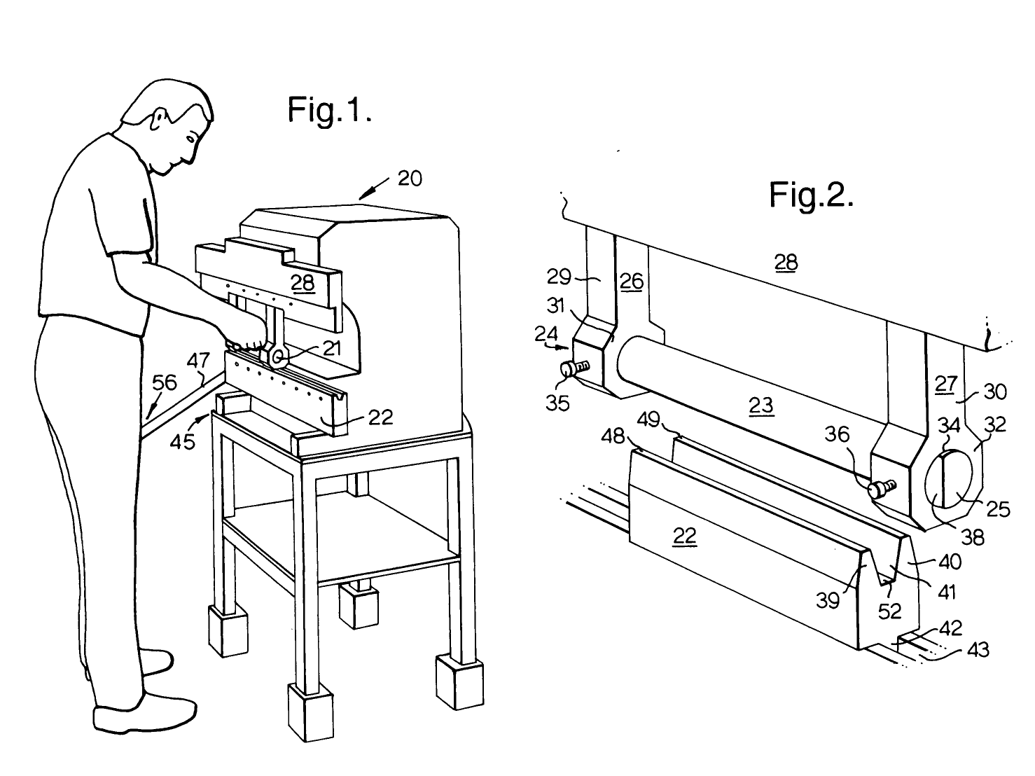

FIG. 1 is a perspective view of a press according to an embodiment of the present invention;

FIG. 2 is a partial view of the press of FIG. 1;

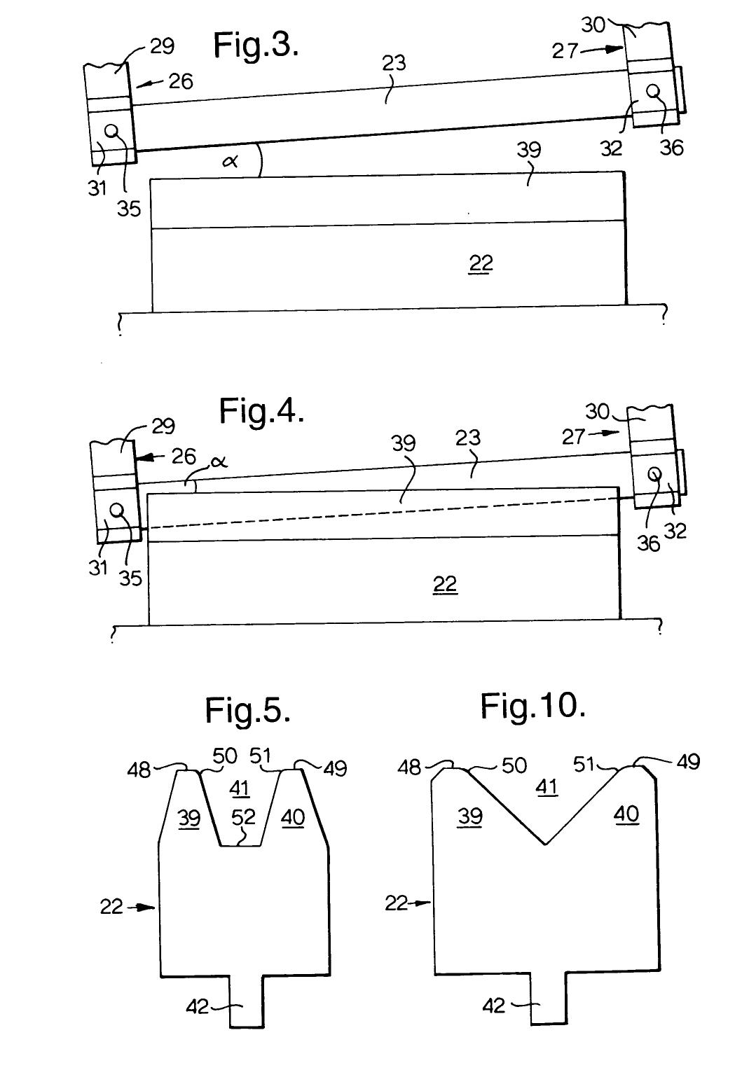

FIG. 3 is a partial side view of the press of FIG. 1 with the tool in a raised position;

FIG. 4 is a partial side view of the press of FIG. 1 with the tool in a lowered position;

FIG. 5 is an end view of a die shown in FIG. 1;

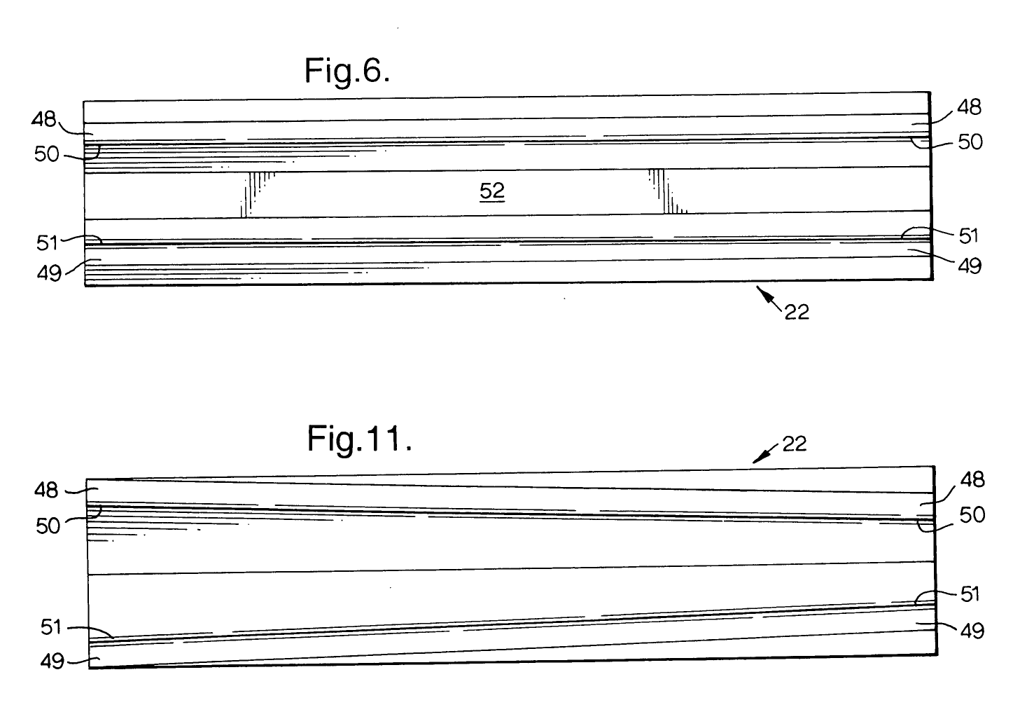

FIG. 6 is a plan view of the die of FIG. 5;

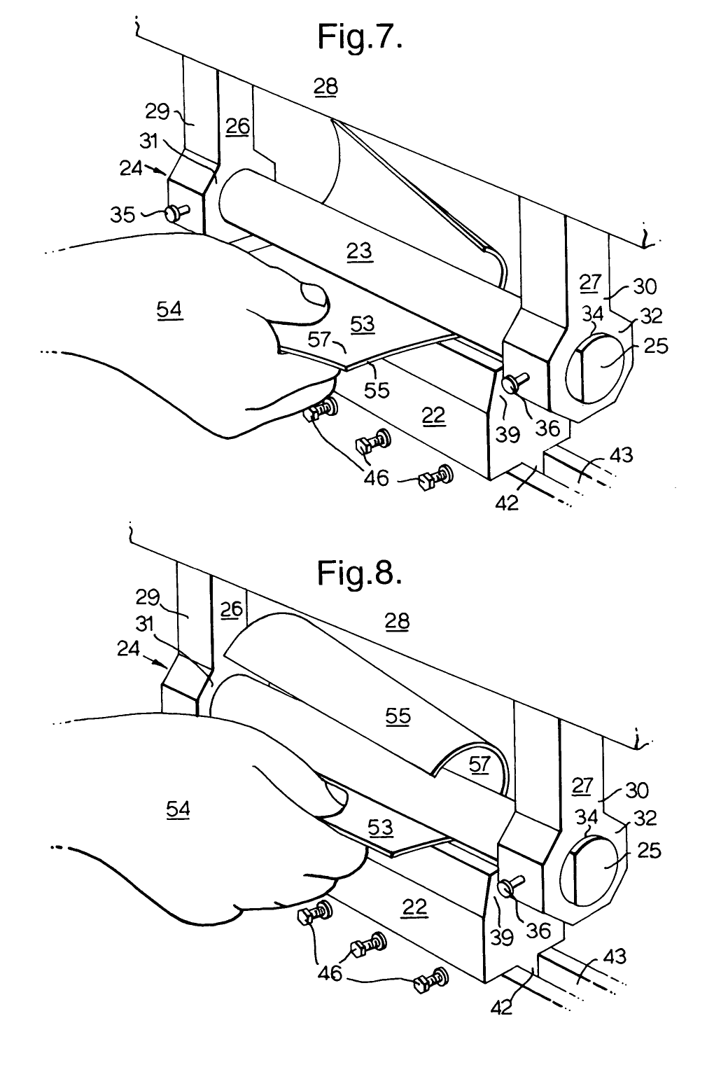

FIG. 7 is a perspective view showing the press of FIG. 1 in an early stage of forming a cone;

FIG. 8 shows the press of FIG. 1 at a later stage of forming a cone;

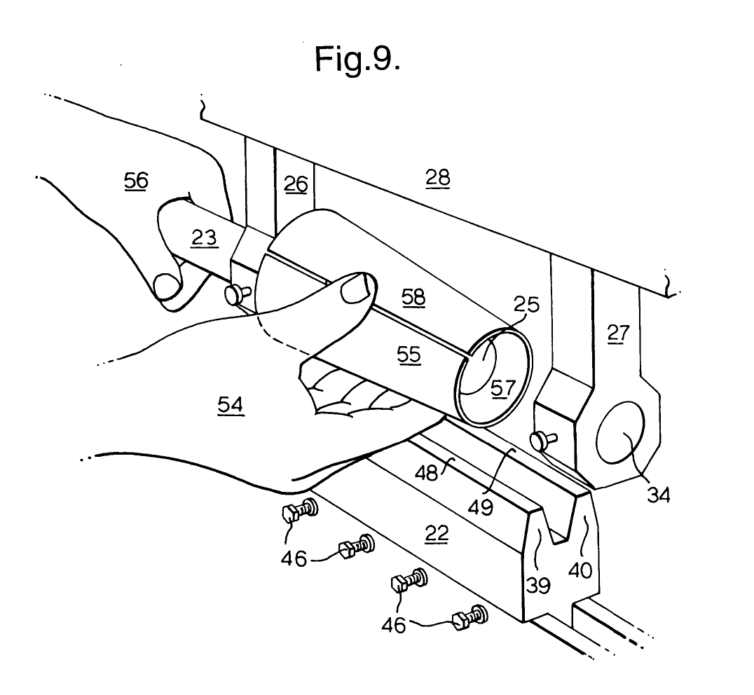

FIG. 9 shows a cone being removed from the press of FIG. 5 after its formation;

FIG. 10 is an end view of a die according to a second embodiment of the invention; and

FIG. 11 is a plan view of a die according to a third embodiment of the invention.

FIG. 1 shows a first embodiment of the present invention, namely a press 20 including a tool 21 and a die 22. The tool 21 and die 22 can be seen in more detail in FIGS. 2 to 4. The tool 21 comprises an elongate cylindrical bar 23 held at its ends 24, 25 by two supports 26, 27 which depend from an upper section 28 of the press 20.

Each support 26, 27 comprises a body 29, 30 with an enlarged head 31, 32 provided at its distal end. Aligned through-holes 33, 34 are provided in the enlarged heads 31, 32 to receive the bar 23, the size of the through-holes 33, 34 being a clearance fit for the bar 23. The bar 23 is held in place by bolts 35, 36 that screw through threaded holes provided in the enlarged heads 31, 32 to enter the through-holes 33, 34 and abut against aligned flat surfaces 37, 38 of the bar 23.

The die 22 has a pair of arm members in the form of two parallel ridges 39, 40 that extend along its entire length, the ridges 39, 40 defining a gap or channel 41 therebetween. A tongue 42 extends from a lower side of the die 22, as best seen in FIG. 5. The tongue 42 is clamped in a slot 43 of a lower section 45 of the press 20 by spaced bolts 46, as best seen in FIGS. 7 to 9.

Rotation of a lever arm 47 moves the upper section 28 of the press 20 up and down and, therefore, controls lowering and raising the bar 23 into and out of the channel 41. FIGS. 2 and 3 show the upper section 28, and hence bar 23, in a raised position where it is clear of the die 22. The die 22, which is shorter than the elongate bar 23, is positioned centrally between the heads 31, 32, so that as the bar 23 moves downward into the channel 41 between the ridges 39, 40, the heads 31, 32 pass either end of the die 22. Hence, at its maximum downward travel, the bar 23 is in a lowered position interposed between the ridges 39, 40 as best shown in FIG. 4.

FIGS. 3 and 4 show that the bar 23 is held at an angle to the ridges 39, 40, the ridges 39, 40 being disposed horizontally, so that one end 24 of the bar 23 penetrates the channel 41 before the other end 25, as it is lowered vertically. Hence, the bar 23 is not parallel with either ridge 39, 40 when viewed from the side. The parallel ridges 39, 40 have flat top surfaces 48, 49 and rounded forming shoulders 50, 51 on either side of the channel 41, which is ‘u’-shaped with a flat bottom 52.

A method of forming a cone from a metal sheet 53 using the press 20 of FIG. 1 will now be described.

A metal sheet 53 is placed into the press 20 with the bar 23 raised. The metal sheet 53 is held by one hand 54 with a bottom surface 55 of the metal sheet 53 resting on the top surfaces 48, 49 of the ridges 39, 40. A rear edge of the metal sheet 53 is aligned to run parallel with the ridges 39, 40 as this allows reproducible alignment of the metal sheet 53 between each forming operation. Moreover, the metal sheet 53 is initially held with only a short section, i.e. a few millimetres, extending beyond the ridge 40. As this short section will not be deformed by the press, it is initially hammered into the desired shape before the metal sheet 53 is placed into the press 20.

The operator then lowers the lever arm 47 with his free hand 56. As the bar 23 is moved downwards, its bottom surface will contact the top surface 57 of the metal sheet 53 and, subsequently, act as a forming surface. Further downward motion of the bar 23 into the channel 41 is resisted by the metal sheet 53 due to the reaction of the shoulders 50, 51 on the bottom surface 55 of the metal sheet 53. However, sufficient force applied to the lever arm 47 will cause the metal sheet 53 to deform as the bar 23 is urged into the channel 41. As the bar 23 progressively penetrates the channel 41, the metal sheet 53 is drawn over the rounded shoulders 50, 51 of the ridges 39, 40. The reaction of the shoulders, 50, 51 and the bar 23 pressing on the opposed surfaces 55, 57 of the metal sheet 53 deforms the metal sheet 53. As the penetration of the bar 23 varies along the length of the channel 41, a part-conical shape is imparted to the metal sheet 53 as can be best seen in FIG. 7 which shows a metal sheet 53 after one forming operation.

Once the first forming operation has been performed, the metal sheet 53 is advanced into the press 20 by a further few millimetres for a second forming operation to be performed as can best be seen in FIG. 7. By progressively feeding the metal sheet 53 into the press 20 and pressing the sheet 53, a cone 58 is progressively formed. FIG. 8 shows the metal sheet 53 being shaped part way through the repeated forming operations and FIG. 9 shows a finished cone 58.

It will be evident that to produce a cone 58 with smoothly curving sides after repeated forming operations requires two conditions to be met. Firstly, the metal sheet 53 must be uniformly fed across the ridges 39, 40 between each forming operation. Secondly, the bar 23 must be lowered into the channel 41 to a consistent depth at each forming operation.

To ensure forming to a consistent depth, the lever arm 47 is linked to the upper section 28 of the press 20 via a cam (not shown) so that, as the lever arm 47 is progressively lowered, the bar 23 is first lowered from its raised position to its fully lowered position and then raised back towards its raised position. The lever arm 47 has a return spring to urge the lever arm 47 back to its upper position, which causes the bar 23 to move back into its fully lowered position before moving again to its raised position.

Cones 58 of varying taper can easily be made using the press 20 of FIG. 1 as follows. The relative angle α between the bar 23 and the die 22 determines the degree of taper of the cone 58 produced by the press 20 and this angle α may be adjusted by varying the pitch of the lower section 45 of the press 20. This is achieved by using bolts (not shown) underneath the lower section 45. Increasing the angle α of the die 22 relative to the bar 23 will produce more highly tapered cones whilst decreasing the angle α will produce less highly tapered cones.

FIGS. 7, 8 and 9 clearly show how the metal sheet 53 wraps itself around the bar 23 as it is shaped into a cone 58. It will be appreciated that the finished cone 58 is trapped on the bar 23 by the supports 26, 27. Accordingly, the bolts 35,36 securing the bar 23 in the supports 26, 27 are loosened so that the bar 23 can be pulled through the supports 26, 27 by the end 25 of the bar 23 that projects beyond the support 27. Hence, the cone 58 is freed from the bar 23, as shown in FIG. 9. Once the cone 58 has been removed, the bar 23 is replaced so that another cone 58 may be made.

A second embodiment of a die 22 in accordance with the present invention is shown in FIG. 10. This die 22 broadly corresponds to the die 22 of FIGS. 5 and 6, and so like reference numerals are used for like parts. As will be appreciated, the die 22 of FIG. 10 has a greater width allowing the ridges 39, 40 to define a wider channel 41 which, in this embodiment, is ‘v’-shaped. The wider channel 41 of FIG. 8 will produce a broader cone 58 when employed in the press 20 of FIG. 1. It will be appreciated that the press 20 would be used in the same way as described hereinabove.

A third embodiment of a die 22 in accordance with the present invention is shown in plan in FIG. 11. The view of the right hand end of the die 22 corresponds to that shown previously in FIG. 5. However, as will be appreciated from FIG. 11, the ridges 39, 40 are no longer parallel but diverge to form a channel 41 that decreases in width from left to right. The top surfaces 48, 49 of the ridges 39, 40 and their rounded shoulders 50, 51 are of uniform width.

The die 22 of FIG. 11 may be used with the press 20 of FIG. 1, preferably with the narrowed end of the channel 41 being placed to coincide with the end 24 of the bar 23 that penetrates the channel 41 most. In this way, the taper of cones produced in the press 20 is increased. Alternatively, the die 22 of FIG. 11 may be used with a modified press where the bar is held horizontally so that, when lowered, the degree of vertical penetration of the bar is uniform along the length of the die 22. The steadily increasing width of the channel 41 ensures that a conical shape is imparted to a metal sheet when pressed.

It will be appreciated by a person skilled in the art that many modifications may be made to the embodiments exemplified above without departing from the scope of the invention.

Although the present invention is particularly suited to forming conical components from sheet metal, other sheet materials such as deformable plastics could be used.

1. A press for forming a conical component from sheet metal or the like comprising two spaced elongate arm members and an elongate tool member movable between a clear position in which the tool member is clear of a gap between the arm members and an interposed position in which at least a portion of th tool member penetrates the gap, one member being disposed out of parall l alignment with at least one of the other members, and wherein th conical component wraps itself around the elongate tool member as it is formed.

2. A press according to claim 1, wherein, in the interposed position, the penetration of the tool member into the gap is greater at one end of the tool member than the other.

3. A press according to claim 1 or 2, wherein the arm members diverge along their length.

4. A press according to any preceding claim, wherein, in the interposed position, the tool member is substantially equidistant from the arm members.

5. A press according to any preceding claim, wherein the tool member is supported at only one end portion in cantilever fashion.

6. A press according to any of claims 1 to 4, wherein the tool member is detachably supported at both end portions.

7. A press according to any preceding claim, wherein a support for the tool member is clear of the arm members when the tool member is moved into the interpos d position.

8. A press according to any preceding claim, wherein a forming portion of the tool member has a curved forming surface.

9. A press according to any preceding claim, wherein the tool member is a solid bar.

10. A press according to any preceding claim, wherein the travel of the tool member into the gap is limited by limiting means.

11. A press according to claim 10, wherein progressive movement of a lev r arm causes reciprocating motion of the tool member from the clear position into the interposed position and then back towards the clear position.

12. A press according to claim 11, wherein the reciprocating motion is effected by a cam.

13. A press according to any preceding claim, wherein the arm members are formed integrally in a die.

14. A press according to claim 13 when appendant to claim 2, wherein the press is adapted to allow selection of the tilt of the die relative to the tool.

15. A method of forming a conical component from a metal sheet or the like having first and second opposed sides, the method comprising the steps of:
a) supporting the first side of the metal sheet with two spaced elongate arm members of a press and moving a tool member of the press towards the arm members to contact the second side of the metal sheet and subsequently to urg the metal sheet into a gap between the arm members, a member-contacted length of the metal sheet not being parallel with at least one of the other member-contacted lengths of the metal sheet;
b) moving the metal sheet across the arm members; and
c) repeating the movement of the tool member;
wherein steps b) and c) cause the conical component to wrap itself around the tool member as it is formed.

16. A tool for forming a conical component from sheet metal substantially as hereinbefore described with reference to the accompanying drawings.

17. A method of forming a conical component from sheet metal substantially as hereinbefore described.
